(19) United States
(12) Patent Application Publication
(10) Pub. No.: US 2025/0272260 A1
(43) Pub. Date: Aug. 28, 2025

(54) TRANSMITTING MODULE AND METHOD FOR TRANSMITTING DIFFERENTIAL SIGNALS IN A SERIAL BUS SYSTEM

(71) Applicant: Robert Bosch GmbH, Stuttgart (DE)

(72) Inventors: Christian Mages, Stuttgart (DE); Steffen Walker, Reutlingen (DE)

(21) Appl. No.: 19/051,251

(22) Filed: Feb. 12, 2025

(30) Foreign Application Priority Data
Feb. 28, 2024 (DE) 10 2024 201 841.4

(51) Int. Cl. G06F 13/40

(52) U.S. Cl. CPC G06F 13/4068

(57) ABSTRACT

A transmitting module for transmitting differential signals in a serial bus system. The transmitting module has a first transmission stage for generating transmission currents for a first signal to be sent to a bus, a second transmission stage for generating transmission currents for a second signal to be sent to the bus as a signal differential to the first signal, a third transmission stage for generating transmission currents for the first signal, and a fourth transmission stage for generating transmission currents for the second signal. The first to fourth transmission stages are connected in a full bridge. The first and fourth transmission stages are connected in series. The third and second transmission stages are connected in series. The first to fourth transmission stages each have at least two current stages, each of which has a switchable resistor, wherein the switchable resistors of a transmission stage have different resistance values.

### CROSS REFERENCE

The present application claims the benefit under 35 U.S.C. § 119 of German Patent Application No. DE 10 2024 201 841.4 filed on Feb. 28, 2024, which is expressly incorporated herein by reference in its entirety.

### FIELD

The present invention relates to a transmitting module and to a method for transmitting differential signals in a serial bus system, in which in particular a voltage source of Vcc=3.3 V is used for transmitting/receiving devices.

### BACKGROUND INFORMATION

Differential signals are used, for example, in CAN bus systems or in Ethernet bus systems according to the 10-BASE-T1S standard for data transmission on a bus. Devices in vehicles and/or other technical facilities are connected to the bus. The signals serially signal the data that need to be transmitted for communication between the devices via the bus. The devices form subscriber stations, which are also called nodes, on the bus. Each subscriber station has at least one transmitting/receiving device, also called a transceiver.

For data transmission with CAN, for example, Classical CAN and CAN FD are standardized in the international standard ISO 11898-1:2015. CAN FD is currently often used with a 2 Mbit/s data bit rate and a 500 kbit/s arbitration bit rate. So-called CAN SIC transmitting/receiving devices make the use of CAN FD with up to 8 Mbit/s possible. CAN XL is now available for higher data rates of currently up to 20 Mbit/s. In all CAN-based bus systems mentioned, for a transmit signal TxD, a bus signal CAN_H and, ideally simultaneously, a bus signal CAN_L are separately driven onto a bus. At least in the first communication phase, in the bus signals CAN_H, CAN_L, one bus state is actively driven. The other bus state is not driven and arises due to a terminating resistor for bus lines or bus wires of the bus. As a result of the differently driven states, in a real bus system with spur lines, mismatches, etc., the signal shapes of the bus signals CAN_H, CAN_L can deviate from the ideal signal shape. This can lead to errors in the evaluation of the bus signals received from the bus.

Currently, CAN bus systems use a voltage source of Vcc=5 V for the transmitting/receiving devices (transceivers) to generate the different voltage levels for the differential signals on the bus.

For reducing costs, it is contemplated to use a voltage source of Vcc=3.3 V for the transmitting/receiving devices. Such a reduction in the supply voltage would be advantageous since the voltage of 3.3 V is used in many of today's microcontrollers. In addition, many other modules can also be supplied with this voltage.

Reducing the supply voltage from 5 V to 3.3 V gives the desired advantage only if existing devices for a CAN bus with a voltage supply of 5 V can still be used. In this case, any number of 5V subscriber stations (5V nodes) and any number of 3.3V subscriber stations (3.3V nodes) must be able to communicate simultaneously on a bus.

It must be taken into account that today's CAN bus has an average voltage of Vcc/2, i.e., 2.5 V, due to the differential signals CAN_H, CAN_L. This is achieved by each bus subscriber station attempting by means of a current source via a standardized resistor network to keep the bus more or less exactly at 2.5 V. The bus voltage substantially follows the lowest node voltage (voltage at the subscriber station) and is therefore typically slightly below 2.5 V.

When transmitting, a CAN subscriber station (node), more precisely its transmitting/receiving device, can switch between a dominant state and a recessive state. For the dominant state, it drives the CAN_H level to approximately 3.5 V and the CAN_L level to approximately 1.5 V. The difference between the CAN_H level and the CAN_L level is then in a range of 2 V. International standard ISO11898-1:2015 requires a minimum of 1.5 V. The transition from the recessive to the dominant state or back takes place as symmetrically as possible around the virtual zero line, which is Vcc/2. This keeps the sum of the levels of CAN_H and CAN_L as close to 5 V as possible.

A major problem is that even small deviations in the mV range result in significant electromagnetic emissions, which cause EMC interference (EMC=electromagnetic compatibility) in other electrical devices. Therefore, there are specifications for maximum permissible electromagnetic emissions which must be met by each transmitting/receiving device (transceiver). However, these requirements for electromagnetic emissions represent a huge challenge.

In comparison to CAN FD, in the arbitration phase, which is also referred to as SIC operating mode or SIC mode, in addition to the recessive (rec) and dominant (dom) states a third state, namely the sic state, must be generated for transceivers for CAN-SIC or transceivers for CAN-XL. In order to meet the emission requirements of the IEC 62228-3 standard, a common mode voltage of the bus lines for signals CAN_H, CAN_L in three transmission states, namely recessive, dominant, sic, must be kept within narrow limits. The common mode voltage is generated at a common mode choke, which is used in particular in a certification measurement to check compliance with the IEC62228-3 standard. The common mode choke is also called “CMC”. The common mode choke has the task of allowing differential signals (DM=differential mode) to pass through as unaffected as possible and of suppressing common mode signals (CM=common mode) as completely as possible. In real operation, however, the common mode choke generates from a differential signal with no common-mode component at the input a differential signal with an undesirable superimposed common-mode signal at the output. This is unfavorable, since it is fed directly into the CAN bus on the bus side and is visible to other CAN modules.

The challenges are even greater in mixed operation if at least one subscriber station on the bus has a transmitting/receiving device (transceiver) that, in the dominant state, drives different voltage levels for CAN_H and CAN_L than the transmitting/receiving devices (transceivers) of other subscriber stations. The reasons for this are as follows.

If parameters of the physical layer are changed, it is usually highly time-consuming to restore interoperability between the subscriber stations. It is therefore desirable for a 3.3V CAN bus to function the same as the 5V CAN bus, except that the voltages on the bus are different. The physical layer corresponds to the bit transmission layer or layer 1 of the conventional OSI model (Open Systems Interconnection Model).

Thus, a 3.3V node (subscriber station) must bring the CAN_H signal to about 3 V and the CAN_L signal to well below 1 V for the dominant state on the bus in order to exceed the specified minimum level difference of 1.5 V.

A special feature of mixed operation is that a 5V node in the recessive phase sets the bus to 2.5 V, while a 3V node aims at approximately 1.65 V on the bus. By increasing the CAN_L voltage in a 3.3V CAN toward 1 V, the voltage in the recessive state can be increased to approximately 1.9 V. However, a difference of approximately 500-600 mV remains between the 5V and 3.3V nodes. In such a configuration, the bus takes on a voltage somewhere between 1.9 V and 2.5 V, and a current constantly flows toward the 3.3V node, but this current is in the range of a few microamperes.

If a subscriber station (node) starts to transmit and switches to the dominant state, the subscriber station (node) does not do so from “its” zero line but from that of the mixed operation. As a result, the sum of the levels of CAN_H and CAN_L changes when switching, and again when switching back.

This inevitably leads to high EMC emissions. Mixed operation is thus not so easily possible.

### SUMMARY

It is an object of the present invention to provide a transmitting module and a method for transmitting differential signals in a serial bus system which solve the aforementioned problems. In particular, the transmitting module and the method for transmitting differential signals in a serial bus system should make possible the compensation of disturbances that affect the emission behavior of the transmitting module.

The object may be achieved by a transmitting module for transmitting differential signals in a serial bus system having certain features of the present invention. According to an example embodiment of the present invention, the transmitting module has a first transmission stage for generating transmission currents for a first signal to be sent to a bus of the bus system, a second transmission stage for generating transmission currents for a second signal to be sent to the bus as a signal differential to the first signal, a third transmission stage for generating transmission currents for the first signal, and a fourth transmission stage for generating transmission currents for the second signal, wherein the first to fourth transmission stages are connected in a full bridge, in which the first and fourth transmission stages are connected in series and the third and second transmission stages are connected in series, wherein each of the first to fourth transmission stages has at least two current stages that are connected in parallel to one another, wherein each of the at least two current stages has a switchable resistor, wherein the switchable resistors of a transmission stage have different resistance values, wherein the first to fourth transmission stages each have a polarity reversal diode for protection against positive feedback into a bus voltage supply terminal and negative feedback from a ground terminal, wherein the polarity reversal diode of the first transmission stage and the third transmission stage is each a switched polarity reversal diode that can be bypassed or short-circuited, and wherein the polarity reversal diode of the second transmission stage and the fourth transmission stage is each a pn-based polarity reversal diode that is a parasitic of a transistor and is hard-wired so that the polarity reversal diode cannot be bypassed or short-circuited.

The described transmitting module of the present invention makes possible the operation in a bus system according to the international standards for CAN also with a voltage supply of 3.3 V. In addition, operation is also possible in a bus system in which 3.3V subscriber stations and 5V subscriber stations are present, thus allowing mixed operation. Even in the case of mixed operation in a CAN bus system, it is easily ensured that the required limit values for the emission of a transmitting/receiving device can be met also for CAN XL. The transmitting module complies in particular with the IEC 62228-3 standard, which specifies limit values to be complied with for the bus states dom, sic and rec.

For example, the above-described transmitting module of the present invention in the sic state can adapt the impedance between the bus lines for the CAN_H and CAN_L signals very well to the characteristic impedance or impedance of the bus line used. The impedance Zw of the bus line used is Zw=100 ohms or Zw=120 ohms. As a result, the transmitting module prevents reflections and thus allows operation in the bus system at higher bit rates.

Since the four transmission stages of the transmitting module are divided into n parts, the described transmitting module of the present invention allows a temporally staggered and controlled switching process and can in particular represent the required 3V CAN levels. Switching on according to the Gaussian error function is possible. This allows smooth behavior to be set during the switch-on process. In addition, the possible variation in time intervals during switch-on prevents the occurrence of a narrow-band frequency line in the emission frequency spectrum.

Alternatively, according to an example embodiment of the present invention, it is possible to use the described transmitting module to carry out a staggered and controlled switching process by means of fixed time steps and varied voltage steps. This too allows the emission behavior of the transmitting module to be influenced in such a way that the specified limit values are complied with.

In addition, the described transmitting module of the present invention can reduce effects due to asymmetrical behavior of the transmission stages, which can occur in the transmission states dom, sic, rec and which worsen the emission. The transmitting module prevents unequal behavior of components in transmission stages A, B (effect 1) of a full bridge, so that in the dom state a change in the common mode voltage in comparison with the rec state is minimized or prevented. In addition, the transmitting module can prevent unequal behavior of components in transmission stages A/D and C/B of the full bridge (effect 2), so that in the sic state a change in the common mode voltage in comparison with the rec state is minimized or prevented. This is particularly advantageous, since only if, starting from the common mode level of the rec state, the common levels in the dom state and in the sic state match those of the rec state, a sufficient emission result can be achieved, but the causes that lead to the behavior of effect 1 may be different from those that lead to effect 2.

Advantageous further embodiments of the transmitting module of the present invention are disclosed herein.

According to an example embodiment of the present invention, the output terminals of the full bridge can be intended for connection to a terminating resistor of the bus.

In one example embodiment of the present invention, the first to fourth transmission stages each have a polarity reversal diode for protection against positive feedback into a bus voltage supply terminal and negative feedback from a ground terminal, wherein the polarity reversal diode of the first transmission stage and the third transmission stage is each a switched polarity reversal diode that can be bypassed or short-circuited, and wherein the polarity reversal diode of the second transmission stage and the fourth transmission stage is each a pn-based polarity reversal diode that is a parasitic of a transistor and is hard-wired so that the polarity reversal diode cannot be bypassed or short-circuited.

In one example embodiment of the present invention, the output terminals of the full bridge are provided for connection to a terminating resistor of the bus.

It is possible for the polarity reversal diodes to be designed to set a bus midpoint voltage of about 1.9 V when the transmitting module is operated with a voltage supply of about 3.3 V.

In one example embodiment of the present invention, the first transmission stage and the third transmission stage each have a polarity reversal circuit which has the polarity reversal diode, a first transistor, a second transistor and a resistor, wherein the second transistor has an on-resistance value that is much smaller than a resistance value of the resistor. Here, the drain terminal of the first transistor can be connected to the anode of the polarity reversal diode, wherein the source terminals of the first and second transistors are connected to the cathode of the polarity reversal diode, wherein the gate terminal of the first transistor is connected to the drain terminal of the second transistor and is connected to the ground terminal via the resistor, wherein the gate terminal of the second transistor is connected to the bus voltage supply terminal.

Optionally, according to an example embodiment of the present invention, the path from gate terminal to source terminal of the first transistor has a filter for protection against pulsed disturbances.

A number n of the at least two current stages may be the same for each of the first to fourth transmission stages, n being a natural number greater than 1.

In one example embodiment of the present invention, each of the at least two current stages has a CMOS transistor for switching the resistance of the current stage.

According to one exemplary embodiment of the present invention, the CMOS transistor of the current stages of the first transmission stage is a PMOS transistor, wherein the CMOS transistor of the current stages of the second transmission stage is an NMOS transistor, wherein the CMOS transistor of the current stages of the third transmission stage is a PMOS transistor, and wherein the CMOS transistor of the current stages of the fourth transmission stage is an NMOS transistor.

Here, in addition, each of the first to fourth transmission stages can have a polarity reversal diode for protection against positive feedback into a bus voltage supply terminal and negative feedback from a ground terminal, and at least one cascode to protect the CMOS transistors.

According to another exemplary embodiment of the present invention, at least two cascodes are connected in parallel to one another, wherein a number y of the cascodes is the same for each of the first to fourth transmission stages, wherein y is a natural number greater than 1, and wherein the on-resistance of the at least two cascodes is different.

The transmitting module can also have at least one first current limiting module as a current source, which is connected between a bus voltage supply terminal and the full bridge, and at least one second current limiting module as a current sink, which is connected between a ground terminal and the full bridge.

According to one exemplary embodiment of the present invention, at least two first current limiting modules are connected in parallel to one another, the on-resistance of which is different, wherein at least two second current limiting modules are connected in parallel to one another, the on-resistance of which is different, and wherein the number x of the first current limiting modules is equal to the number x of the second current limiting modules, x being a natural number greater than 1.

According to an example embodiment of the present invention, the transmitting module can also have a control circuit for controlling switchable components of the first to fourth transmission stages according to a digital transmit signal and operating mode set for the transmitting module. The control circuit may be designed for the temporally staggered and controlled switching of the resistance values of at least two current stages.

The above-described transmitting module of the present invention can be part of a transmitting/receiving device for a subscriber station for a serial bus system, said transmitting/receiving device also having a receiving module for receiving signals from the bus.

The transmitting/receiving device of the present invention can be part of a subscriber station for a serial bus system, said subscriber station also having a communication control device for controlling the communication in the bus system and for generating a digital transmit signal for controlling the first to fourth transmission stages.

According to an example embodiment of the present invention, the subscriber station may be designed for communication in a bus system in which an exclusive, collision-free access of a subscriber station to the bus of the bus system is guaranteed at least temporarily.

The aforementioned object of the present invention may also achieved by a method for transmitting differential signals in a serial bus system having certain features of the present invention. According to an example embodiment of the present invention, the method is carried out with a transmitting module, wherein the method comprises the steps of: generating, with a first transmission stage, transmission currents for a first signal to be sent to a bus of the bus system; generating, with a second transmission stage, transmission currents for a second signal to be sent to the bus as a signal differential to the first signal; generating, with a third transmission stage, transmission currents for the first signal; and generating, with a fourth transmission stage, transmission currents for the second signal, wherein the first to fourth transmission stages are connected in a full bridge, in which the first and fourth transmission stages are connected in series and the third and second transmission stages are connected in series, wherein each of the first to fourth transmission stages has at least two current stages that are connected in parallel to one another, wherein each of the at least two current stages has a switchable resistor, and wherein the switchable resistors of a transmission stage have different resistance values, wherein the first to fourth transmission stages each use a polarity reversal diode for protection against positive feedback into a bus voltage supply terminal and negative feedback from a ground terminal, wherein the polarity reversal diode of the first transmission stage and the third transmission stage is each a switched polarity reversal diode that can be bypassed or short-circuited, and wherein the polarity reversal diode of the second transmission stage and the fourth transmission stage is each a pn-based polarity reversal diode that is a parasitic of a transistor and is hard-wired so that the polarity reversal diode cannot be bypassed or short-circuited.

The method of the present invention offers the same advantages as mentioned above with respect to the transmitting module of the present invention.

Further possible implementations of the present invention also include combinations, even those not explicitly mentioned, of features or embodiments described above or below with respect to the exemplary embodiments. In this case, a person skilled in the art will also add individual aspects as improvements or additions to the relevant basic form of the present invention.

### BRIEF DESCRIPTION OF THE DRAWINGS

The present invention is described in more detail below with reference to the figures and on the basis of exemplary embodiments.

FIG. 1 shows a simplified block diagram of a bus system according to a first exemplary embodiment of the present invention.

FIG. 2 shows a diagram for illustrating the structure of a message which can be transmitted by a first subscriber station of the bus system according to the first exemplary embodiment of the present invention.

FIG. 3 shows a time profile of a digital transmit signal during operation of the bus system at the first and/or second subscriber station, which is connected with at least a first subscriber station to the same bus of the bus system.

FIG. 4 shows a time profile of bus signals CAN_H and CAN_L at the second subscriber station according to the first exemplary embodiment of the present invention.

FIG. 5 shows a time profile of a differential voltage VDIFF of the bus signals CAN_H and CAN_L at the first and the second subscriber station according to the first exemplary embodiment of the present invention.

FIG. 6 shows a time profile of a digital receive signal which the first or second subscriber station generates from a signal received from the bus and which is based on the transmit signal of FIG. 3.

FIG. 7 shows a time profile of bus signals CAN_H and CAN_L, which can be generated on the bus by the first subscriber station according to the first exemplary embodiment of the present invention, starting from the transmit signal of FIG. 3.

FIG. 8 shows an example of a time profile of a digital transmit signal which is to be converted in an arbitration phase (SIC operating mode of a transmitting module) into bus signals CAN_H, CAN_L for a bus of the bus system of FIG. 1.

FIG. 9 shows the time profile of the bus signals CAN_H, CAN_L during switching from a recessive bus state to a dominant bus state and back to the recessive bus state, which bus signals are transmitted onto the bus in the arbitration phase (SIC operating mode) due to the transmit signal of FIG. 8.

FIG. 10 shows a circuit diagram of a transmitting module for a subscriber station of the bus system according to the first exemplary embodiment of the present invention.

FIG. 11 shows a time graph illustrating the switching on of various current stages of a transmission stage for a first specific example of the transmitting module of FIG. 10.

FIG. 12 shows a detail of a transmission stage for a second specific example of the transmitting module of FIG. 10.

FIG. 13 shows a circuit diagram of a transmitting module for a subscriber station of the bus system according to a second exemplary embodiment of the present invention.

In the figures, identical or functionally identical elements are given the same reference signs unless otherwise indicated.

### DETAILED DESCRIPTION OF EXAMPLE EMBODIMENTS

FIG. 1 shows a bus system 1, which can, for example, at least in sections, be a CAN bus system, a CAN FD bus system, etc. The bus system 1 can be used in a vehicle, in particular a motor vehicle, an aircraft, etc., or in a hospital, etc. In FIG. 1, the bus system 1 has a plurality of subscriber stations 10, 20, 30, which are each connected to a bus 40 or bus line having a first bus wire 41 and a second bus wire 42. In a CAN bus system, the bus wires 41, 42 can also be called CANH and CANL for carrying signals CAN_H, CAN_L on the bus 40.

Messages 45, 46, 47 in the form of signals are transferred between the individual subscriber stations 10, 20, 30 via the bus 40. The subscriber stations 10, 20, 30 are, for example, control devices or display devices of a motor vehicle.

As shown in FIG. 1, the subscriber stations 10, 30 each have a communication control device 11 and a transmitting/receiving device 12. The transmitting/receiving device 12 has a transmitting module 121 and a receiving module 122. The subscriber station 10 uses a supply voltage of 3.3 V, at least 3.0 V. At least one of the subscriber stations 20, 30 uses a supply voltage of 5 V. For illustration purposes, the following embodiments show an example of a network or bus system 1 in which subscriber station 20 has a supply voltage of 5 V and subscriber stations 10 and 30 have a supply voltage of 3.3 V, at least 3.0 V. Other constellations are also possible.

The subscriber station 20 has a communication control device 21 and a transmitting/receiving device 22. The transmitting/receiving device 22 has a transmitting module 221 and a receiving module 222.

The transmitting/receiving devices 12 of the subscriber stations 10, 30 and the transmitting/receiving device 22 of the subscriber station 20 are each directly connected to the bus 40, even though this is not shown in FIG. 1.

The communication control devices 11, 21 are each used for controlling communication of the corresponding subscriber station 10, 20, 30 via the bus 40 with at least one other subscriber station of the subscriber stations 10, 20, 30 which are connected to the bus 40.

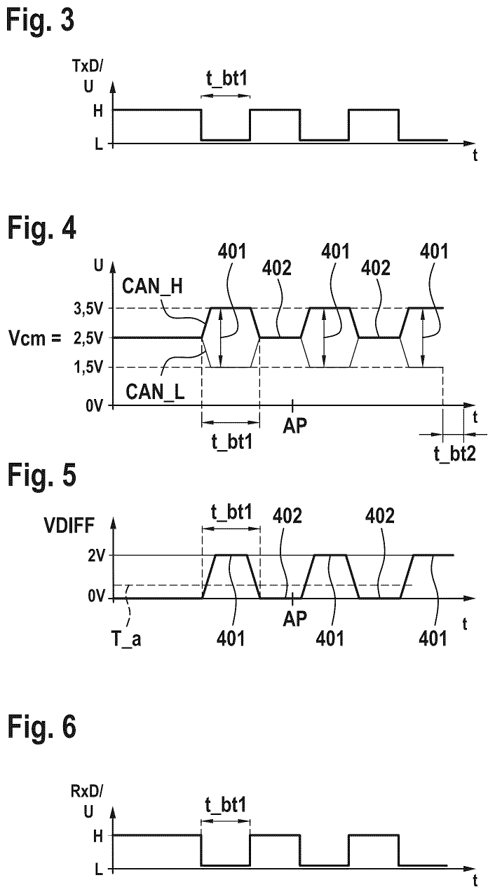

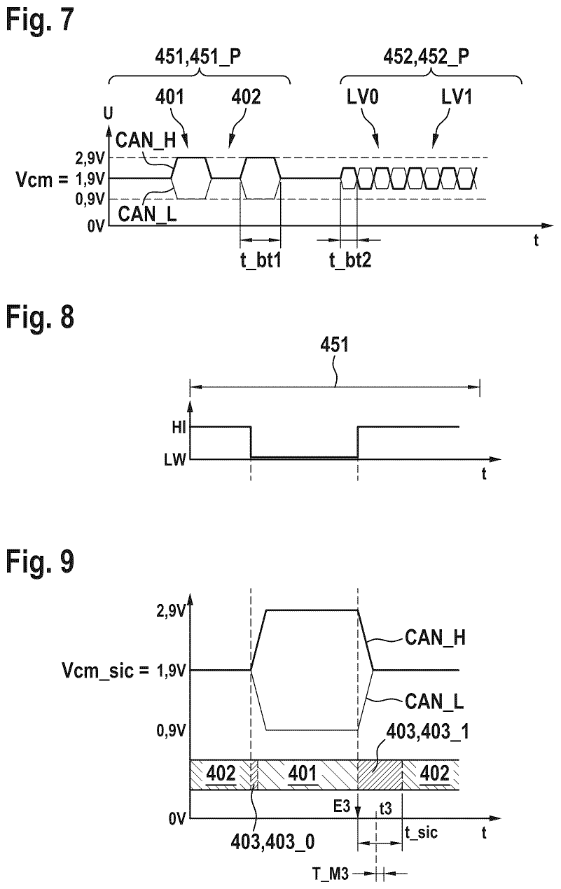

The communication control devices 11 create and read first messages 45, 47, which are, for example, modified CAN messages 45, 47. Here the modified CAN messages 45, 47 are based on the CAN XL format, for example. The transmitting/receiving device 12 is used to transmit and receive the messages 45, 47 to/from the bus. The transmitting module 121 receives a digital transmit signal TxD created by the communication control device 11 for one of the messages 45, 47 and converts it into signals on the bus 40, as described in more detail with reference to FIG. 3, FIG. 4, and FIG. 7. The digital transmit signal TxD can be a pulse-width-modulated signal, at least temporarily or in sections. The receiving module 121 receives signals transmitted on the bus 40 corresponding to the messages 45 to 47 and generates a digital receive signal RxD therefrom, for which an example is shown in FIG. 6. The receiving module 122 transmits the receive signal RxD to the communication control device 11.

In addition, the communication control device 11 can optionally be designed to create and read second messages 46, which are, for example, CAN FD messages 46. The transmitting/receiving device 12 can be designed accordingly.

The communication control device 21 can be designed as a conventional CAN controller according to ISO 11898-1:2015, i.e. as a CAN FD-tolerant Classical CAN controller or as a CAN FD controller. The communication control device 21 creates and reads second messages 46, for example CAN FD messages or CAN SiC messages. The transmitting/receiving device 22 is used to transmit and receive the messages 46 to/from the bus 40. The transmitting module 221 receives a digital transmit signal TxD created by the communication control device 21 and converts it into signals for a message 46 on the bus 40, as described in more detail with reference to FIG. 3 and FIG. 4. The receiving module 222 receives signals transmitted on the bus 40 corresponding to the messages 45 to 47 and generates a digital receive signal RxD therefrom, for which an example is shown in FIG. 6. The transmitting/receiving device 22 may be designed like a conventional CAN FD transceiver or CAN SiC transceiver.

For transmitting the messages 45, 46, 47 with CAN SIC or CAN XL, proven properties that are responsible for the robustness and user friendliness of CAN and CAN FD, in particular the frame structure with the identifier and the arbitration according to the conventional CSMA/CR method, are adopted, as described in more detail below.

With the two subscriber stations 10, 30, a formation and then a transmission of messages 45, 46, 47 with different CAN formats, in particular the CAN FD format or the CAN SIC format or the CAN XL format, as well as the reception of such messages 45, 46, 47 can be realized. This is described in more detail below for a message 45.

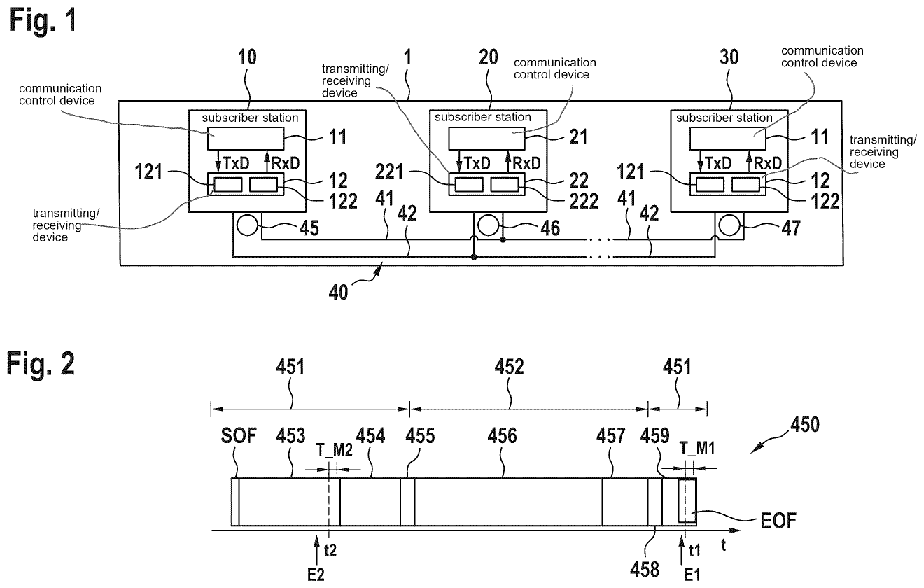

FIG. 2 shows, for the message 45, a frame 450, which is in particular a CAN XL frame, said frame being provided by the communication control device 11 for the transmitting/receiving device 12 for transmission onto the bus 40. In this case, the communication control device 11 creates the frame 450 as compatible with CAN FD in the present exemplary embodiment. Alternatively, the frame 450 is compatible with any successor standard for CAN FD.

According to FIG. 2, the frame 450 is divided, for CAN communication on the bus 40, into different communication phases 451, 452, namely an arbitration phase 451 (first communication phase) and a data phase 452 (second communication phase). After a start bit SOF, the frame 450 has an arbitration field 453, a control field 454, a first switching field 455, a data field 456, a checksum field 457, a second switching field 458 and a frame termination field 459, in which a marking EOF (EOF=end of frame) is present. The checksum field 457, the second switching field 458 and the frame termination field 459 form a frame end phase 457, 458, 459 of the frame 450. In the frame termination field 459, there may be an acknowledgment field (ACK), which includes at least one ACK bit and which is not shown in the figures.

In contrast to the frame 450 of FIG. 2, no switching fields 455, 458 are present in a CAN FD frame, which the subscriber station 20 uses for the second message 46.

It is true for all aforementioned CAN versions that, in the arbitration phase 451, with the aid of an identifier (ID) in the arbitration field 453, negotiation takes place bitwise between the subscriber stations 10, 20, 30 as to which subscriber station 10, 20, 30 wishes to transmit the message 45, 46, 47 with the highest priority and is therefore granted exclusive access to the bus 40 of the bus system 1 for the near future for transmitting in the subsequent data phase 452. A physical layer such as in CAN and CAN FD is used in the arbitration phase 451. The physical layer corresponds to the bit transmission layer or layer 1 of the conventional OSI model (Open Systems Interconnection Model).

During the phase 451, the conventional CSMA/CR method is used, which allows simultaneous access of the subscriber stations 10, 20, 30 to the bus 40 without the higher priority message 45, 46, 47 being destroyed. As a result, further bus subscriber stations 10, 20, 30 can be added relatively easily to the bus system 1, which is very advantageous.

The CSMA/CR method has the consequence that there must be so-called recessive states on the bus 40, which can be overwritten by other subscriber stations 10, 20, 30 with dominant levels or dominant states on the bus 40. In the recessive state, high-impedance conditions prevail at the individual subscriber station 10, 20, 30, which in combination with the parasites on the bus circuit results in longer time constants. This leads to a limitation of the maximum bit rate of the present-day CAN-FD physical layer at currently about 2 megabits per second in real vehicle use.

At the end of the arbitration phase 451, switching to the data phase 452 takes place. In the case of CAN XL, switching takes place by means of the first switching field 455 of FIG. 2.

In the case of CAN XL, in the data phase 452, in addition to a portion of the first switching field 455, the payload data of the CAN XL frame 450 or of the message 45 from the data field 456 are transmitted, and so are the checksum field 457 and a portion of the second switching field 458. In the case of CAN FD, the payload data of the CAN FD frame or of the message 46 from the data field 456 are transmitted, and so is the checksum field 457.

At the end of the data phase 452, switching back to the arbitration phase 451 takes place. In the case of CAN XL, switching takes place by means of the second switching field 458 of FIG. 2.

A transmitter of the message 45 does not begin to transmit bits of the data phase 452 onto the bus 40 until the subscriber station 10 as the transmitter has won the arbitration and the subscriber station 10 as the transmitter thus has exclusive access to the bus 40 of the bus system 1 for transmitting.

A bit sequence is provided in the frame end field EOF, which bit sequence marks the end of the frame 450. This means that the bit sequence of the end field (EOF) is used to mark the end of the frame 450. The end field (EOF) ensures that a number of 7 recessive bits is transmitted at the end of the frame 450. Together with an optional ACK delimiter in the acknowledgment field (not shown), a number of 8 recessive bits is transmitted at the end of the frame 450. The mentioned bit sequence of recessive bits is a bit sequence that cannot occur within the frame 450. As a result, the end of the frame 450 can be reliably recognized by the subscriber stations 10, 30.

Starting from a point in time or a time t1, more precisely starting with the time t1, for a time period T_M1, the subscriber station 10 carries out a detection of the bus potential or the bus voltage present on the bus 40. The detection is carried out after an event E1 has occurred. The event E1 is that a predetermined number of directly consecutive recessive bits has occurred at the end of the frame 450, more precisely in the end field (EOF).

Optionally, the subscriber station may, starting from a time t2, more precisely starting with the time t2, for a time period T_M2, carry out a detection of the bus potential or the bus voltage present on the bus 40. The detection is carried out after an event E2 has occurred. The event E2 is that, at the end of the first communication phase (arbitration phase 451), the subscriber station that will have exclusive access to bus 40 in the following second communication phase (data phase 452) and will thus be allowed to transmit its message is ascertained.

This/these detection(s) or measurement(s) is/are described below with reference to the figures.

After the end field (EOF), which has 7 bits, an interframe space (IFS), not shown in FIG. 2, follows in the frame 450. In CAN FD, this interframe space (IFS) is designed in accordance with ISO11898-1:2015. The interframe space (IFS) has at least 3 bits.

Otherwise, the fields and bits mentioned are from ISO 11898-1:2015 and for this reason are not described in more detail here.

Thus, in the arbitration phase 451 as the first communication phase, the subscriber stations 10, 30 use, in part, in particular up to the FDF bit (inclusive), a format from CAN/CAN FD, according to ISO 11898-1:2015. However, in comparison with CAN or CAN FD, an increase in the net data transfer rate, in particular to over 10 megabits per second, is possible in the data phase 452 as the second communication phase. In addition, an increase in the size of the payload data per frame, in particular to about 2 kilobytes or any other value, is possible.

FIG. 3, FIG. 5, and FIG. 6 illustrate, as an example, the signals that are generated at the subscriber stations 10, 20, 30 during operation of the bus system 1. FIG. 4 illustrates, as an example, the signals that are transmitted from the subscriber station 20 to the bus 40 during operation of the bus system 1. As already mentioned, the subscriber station 20 uses a supply voltage of 5 V. FIG. 7 shows the bus signals which each of the subscriber stations 10, 30 generates instead of the bus signals shown in FIG. 4. As already mentioned, the subscriber stations 10, 30 use a supply voltage of about 3.3 V, at least 3.0 V.

During operation of the bus system 1, each of the transmitting modules 121, 221 of FIG. 1 can serially convert a transmit signal TxD of the associated communication control device 11 into corresponding signals CAN_H, CAN_L for CAN or CAN FD for the bus wires 41, 42 and transmit these signals at the terminals for CAN_H and CAN_L onto the bus 40. The corresponding communication control device 11, 21 transmits the transmit signal TxD of FIG. 3 over time t (serially) to the associated transmitting module 121, 221, as shown in FIG. 1.

As shown as an example in FIG. 3, the transmit signal TxD has the voltage states H (high) and L (low) with a corresponding voltage U. The individual bits of the signal TxD have a bit time t_bt1, as shown in FIG. 3 for the arbitration phase 451. In the case of CAN FD and CAN XL, the bits of the TxD signal in the data phase 452 can be transmitted with a shorter bit time t_bt2, as illustrated in FIG. 4.

The sequence of the states H, L of the transmit signal TxD of FIG. 3 and the resulting states 401, 402 for the signals CAN_H, CAN_L in FIG. 4 along with the resulting profile of the voltage VDIFF of FIG. 5 are used only to illustrate the function of the subscriber station 10. The sequence of the data states for the bus states 401, 402 can be selected as required.

According to the example of FIG. 4, the signals CAN_H and CAN_L have, at least in the arbitration phase 451, the dominant and recessive bus levels or bus states 401, 402, as from CAN. Since the subscriber station 20 uses a supply voltage of 5 V, it drives the CAN_H level to approximately 3.5 V and the CAN_L level to approximately 1.5 V for the dominant state 401, as shown in FIG. 4. The recessive state 402 occurs at 2.5 V, which is equal to the bus midpoint voltage Vcm=2.5 V.

As shown in FIG. 5 for the differential voltage VDIFF=CAN_H−CAN_L on the bus 40, the difference between the CAN_H level and the CAN_L level for the dominant state 401 is then in a range of 2 V.

The receiving modules 122, 222 form a receive signal RxD according to FIG. 6 from signals CAN_H and CAN_L received from the bus 40, which are shown in FIG. 4, or from the differential voltage VDIFF of FIG. 5. For generating the digital receive signal RxD of FIG. 6, the respective reception module 122, 222 uses receive thresholds as is conventional. In FIG. 6, the receive signal RxD is shown without propagation delay. The receiving module 122 forwards this receive signal RxD to the associated communication control device 11, 21, as shown in FIG. 1.

According to ISO 11898-1:2015, the communication control device 11, 21 compares its own bits, transmitted according to a frame 450 and a transmit signal TxD (FIG. 3), at the sample point AP (FIGS. 4 and 5) with the bits, observed on the bus 40, according to the receive signal RxD (FIG. 6). A difference is considered an error, except in the case of arbitration and the ACK bit.

In contrast to FIG. 4, FIG. 7 shows the signals CAN_H and CAN_L, which the subscriber stations 10, 30 generate on the bus 40 in the arbitration phase 451 and the data phase 452. At least in the arbitration phase 451, the dominant and recessive bus levels or bus states 401, 402 are used, as already shown in FIG. 4. Since, in the example mentioned, the subscriber stations 10, 30 use a supply voltage of 3.3 V, they drive the CAN_H level to approximately 2.9 V and the CAN_L level to approximately 0.9 V for the dominant state 401, as shown in FIG. 7. The recessive state 402 occurs at 1.9 V, which is equal to the bus midpoint voltage Vcm=1.9 V. In the data phase 452, CAN XL can use a different physical layer 452_P than the physical layer 451_P in the arbitration phase 451. Consequently, the CAN_H levels can be driven to values for the states LV1, LV0, as shown in FIG. 7. A physical layer such as in CAN and CAN FD is used in the arbitration phase 451. The physical layer corresponds to the bit transmission layer or layer 1 of the conventional OSI model (Open Systems Interconnection Model).

For the transmit signal TxD of FIG. 3, the transmitting module 121 generates the signals CAN_H, CAN_L in FIG. 7 for the bus wires 41, 42 in such a way that the state LV0 is formed for a state LW (low). In addition, the state LV1 is formed for a state HI (high).

In order to increase the data rate for CAN XL, the transmitting/receiving devices 12 can be designed for CAN SIC.

As shown in more detail in FIG. 8 and FIG. 9, for the transmit signal TxD of FIG. 8, the transmitting module 121 in CAN SIC generates the signals CAN_H, CAN_L according to FIG. 9 for the bus wires 41, 42 at a bus midpoint voltage Vcm_sic=1.9 V and in such a way that a state 403 (sic) is additionally present. The state 403 (SIC) can have different lengths, as shown with the state 403_0 (sic) during the transition from the state 402 (rec) to the state 401 (dom) and with the state 403_1 (sic) during the transition from the state 401 (dom) to the state 402 (rec). The state 403_0 (sic) is shorter in time than the state 403_1 (sic). In order to generate signals according to FIG. 9, the transmitting module 121 is switched to a SIC operating mode (SIC mode).

Passing through the short sic state 403_0 is not required in CiA610-3 and the state depends on the type of implementation. The duration of the “long” state 403_1 (sic) is specified for CAN SIC as well as for the SIC operating mode in CAN XL as t_sic<530 ns, starting with the rising edge of the transmit signal TxD of FIG. 8.

Starting from a point in time or a time t3, more precisely starting with the time t3, after an event E3 has occurred, for a time period T_M3, the subscriber station 10, in particular the transmitting/receiving device 12, carries out a detection of the bus potential or the bus voltage present on the bus 40. The event E3 is that the state 401 (dom) is left or switching takes place from the state 401 (dom) to the state 403 (sic). Depending on the detection result, the subscriber station 10 sets that either 2.5 V (FIG. 4) or 1.9 V (FIG. 7) is fed to the bus 40 as the bus bias voltage Vcm. The bus bias voltage on the bus 40 or the potential 2.5 V can in particular be set during bit 7 of the frame end field EOF or one of the following 4 recessive bits.

In the “long” state 403_1 (sic), the transmitting module 121 should adapt the impedance between the bus wires 41 (CANH) and 42 (CANL) as well as possible to the characteristic impedance Zw of the bus line used. Here, Zw equals 100 ohms or 120 ohms. This adaptation prevents reflections and thus allows operation at higher bit rates. For the sake of simplicity, hereinafter reference will always be made to the state 403 (sic) or sic state 403.

The transmitting module 121 can be used to generate signals for the bus 40 for the following CAN types: CAN FD, CAN SIC and CAN XL.

TABLE 1
CAN types for transmitting module 121

| | Communication | | Transmitting |
|---|---|---|---|
| CAN type | phases/bit rate | Bus states | module states |
| CAN FD | Arbitration | dom, rec | dom, sic, rec |
| CAN SIC | Arbitration | dom, sic, rec | dom, sic, rec |
| CAN XL | Arbitration or | dom, sic, rec | dom, sic, rec |
| | arbitration | | |
| | and data field | | |
| | for the case | | |
| | in which no | | |
| | switch to the | | |
| | fast operating | | |
| | mode occurs | | |
| CAN XL | Data phase | L0, L1 | L0, L1 |

Thus, the transmitting module state sic can be generated not only with CAN SIC or CAN XL (xl_sic). The transmitting module state sic can also be generated with CAN FD. However, in CAN FD, the time for the transmitting module state sic can be shorter than with CAN SIC or CAN XL.

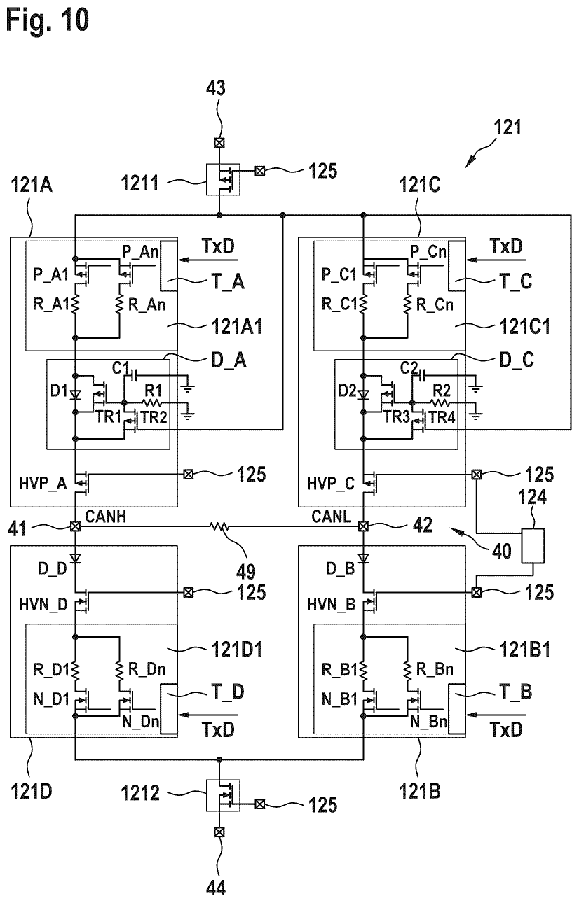

FIG. 10 shows the basic structure of the transmitting module 121 for one of the subscriber stations 10, 30. The transmitting module 12 can generate signals CAN_H, CAN_L according to FIG. 9 with the states 401, 402, 403 and signals CAN_H, CAN_L according to FIG. 7 with the states L0, L1.

The transmitting module 121 has four transmission stages, namely a first transmission stage 121A, a second transmission stage 121B, a third transmission stage 121C, and a fourth transmission stage 121D. As shown in FIG. 10, the transmission stages 121A to 121D are connected as a full bridge. In addition, the transmitting module 121 includes current limiting modules 1211, 1212. The current limiting modules 1211, 1212 and the components of the transmission stages 121A to 121D, which are described in more detail below, are controlled via at least one control device 124. At least one control device 124 transmits at least one signal to control terminals 125 to which the current limiting modules 1211, 1212 and/or the components of the transmission stages 121A to 121D are connected. For the sake of clarity, not all line connections for this purpose are shown in FIG. 10.

The transmitting module 121 is connected to the bus 40, more precisely to its first bus wire 41 for CAN_H or CAN-XL_H and to its second bus wire 42 for CAN_L or CAN-XL_L. Each of the transmission stages 121A to 121D is connected to the bus 40.

The voltage supply for supplying the first and second bus wires 41, 42 with electrical energy, in particular with the voltage CAN-Supply of 3.3 V, is carried out via at least one terminal 43. The connection to ground or CAN_GND is realized via a terminal 44. The first and second bus wires 41, 42 are terminated with a terminating resistor 49. The terminating resistor 49 is connected in the full bridge as an external load resistor. The resistor 49 is connected in the bridge branch between the terminals for the bus wires 41, 42.

The first transmission stage 121A of FIG. 10 has a polarity reversal circuit D_A, a transistor HVP_A and a parallel circuit 121A1, in which a first to an n-th current stage are connected in parallel, n being a natural number >1. In addition, a control circuit T_A is present. The first current stage has a series circuit composed of a resistor R_A1 and a transistor P_A1. The n-th current stage has a series circuit composed of a resistor R_An and a transistor P_An. The transistor HVP_A can be a CMOS transistor, in particular a PMOS transistor. The transistors P_A1 to P_An are CMOS transistors, in particular PMOS transistors. The abbreviation “CMOS” refers to a semiconductor device that uses both p-channel and n-channel MOSFETs on a common substrate. The abbreviation CMOS stands for “complementary metal-oxide-semiconductor”. The abbreviation “MOSFET” stands for “metal oxide semiconductor field-effect transistor”. The control circuit T_A controls the transistors P_A1 to P_An of the first to n-th current stages according to the transmit signal TxD and the set operating mode SIC, FAST_TX of the transmitting module 121.

The second transmission stage 121B of FIG. 10 has a polarity reversal diode D_B, a transistor HVN_B and a parallel circuit 121B1, in which a first to an n-th current stage are connected in parallel, n being a natural number >1. In addition, a control circuit T_B is present. The first current stage S1 has a series circuit composed of a resistor R_B1 and a transistor N_B1. The n-th current stage has a series circuit composed of a resistor R_Bn and a transistor N_Bn. The transistor HVP_B can be a CMOS transistor, in particular an NMOS transistor. The transistors N_B1 to N_Bn are CMOS transistors, in particular NMOS transistors. The control circuit T_B controls the transistors N_B1 to N_Bn of the first to n-th current stages according to the transmit signal TxD and the set operating mode SIC, FAST_TX of the transmitting module 121.

The third transmission stage 121C of FIG. 10 has a polarity reversal circuit D_C, a transistor HVP_C and a parallel circuit 121C1, in which a first to an n-th current stage are connected in parallel, n being a natural number >1. In addition, a control circuit T_C is present. The first current stage has a series circuit composed of a resistor R_C1 and a transistor P_C1. The n-th current stage has a series circuit composed of a resistor R_An and a transistor P_An. The transistor HVP_C can be a CMOS transistor, in particular a PMOS transistor. The transistors P_C1 to P_Cn are CMOS transistors, in particular PMOS transistors. The control circuit T_C controls the transistors P_C1 to P_Cn of the first to n-th current stages according to the transmit signal TxD and the set operating mode SIC, FAST_TX of the transmitting module 121.

The fourth transmission stage 121D of FIG. 10 has a polarity reversal diode D_D, a transistor HVN_D and a parallel circuit 121D1, in which a first to an n-th current stage are connected in parallel, n being a natural number >1. In addition, a control circuit T_D is present. The first current stage has a series circuit composed of a resistor R_D1 and a transistor N_D1. The n-th current stage has a series circuit composed of a resistor R_Dn and a transistor P_Dn. The transistor HVP_D can be a CMOS transistor, in particular an NMOS transistor. The transistors N_D1 to N_Dn are CMOS transistors, in particular NMOS transistors. The control circuit T_D controls the transistors N_D1 to N_Dn of the first to n-th current stages according to the transmit signal TxD and the set operating mode SIC, FAST_TX of the transmitting module 121.

The current stages S1 to Sn of the transmission stages 121A to 121D are thus designed as resistance stages. The resistance stages are set by selecting the resistance value of the corresponding current stage, for example by selecting the resistors R_A1 to R_An for the transmission stage 121A, etc. As a result of setting the resistance values of the resistors, current stages are set. The number n can be chosen arbitrarily. In particular, the number n and thus the number of stages or number of resistance stages or current stages can be selected between 1 and 60. Alternatively, however, a number larger than 60 can be chosen for n.

Each of the polarity reversal diodes D_B, D_D protects the associated transmission stage 121B, 121D against positive feedback to the terminal 44 (CAN-Supply) and negative feedback to the terminal 43 (CAN_GND). Each of the polarity reversal diodes D_B, D_D can also be referred to as a blocking diode. Each of the polarity reversal diodes D_B, D_D can be a pn-based diode, which is a parasitic pn junction of a (silicon) transistor that is hard-wired so that the transistor is never controlled and the diode cannot be short-circuited/bypassed. In particular, the forward voltage of each of the polarity reversal diodes D_B, D_D is about 0.7 V.

Each of the polarity reversal circuits D_A, D_C protects the associated transmission stage 121A, 121C against positive feedback to the terminal 44 (CAN-Supply) and negative feedback to the terminal 43 (CAN_GND). Each of the polarity reversal circuits D_A, D_C can also be referred to as a blocking circuit.

The first polarity reversal circuit D_A has a diode D1, a first transistor TR1, a second transistor TR2, a resistor R1 and optionally a capacitor C1. The diode D1 arises parasitically from the transistor TR1. The transistor TR2 has its own parasitic diode, which is not shown in FIG. 10. The transistors TR1, TR2 are PMOS transistors. The anode of diode D1 is connected to the drain terminal of the first transistor TR1. The cathode of the diode D1 is connected to the source terminal of the first transistor TR1 and to the source terminal of the second transistor TR2. The gate terminal of the first transistor TR1 is connected to the drain terminal of the second transistor TR2, to a terminal of the resistor R1, and to a terminal of the optional capacitor C1. The other terminal of resistor R1 is connected to ground, in particular to terminal 44 (GND). In addition, the other terminal of the optional capacitor C1 is connected to ground, in particular to terminal 44 (GND). The gate terminal of the second transistor TR2 is connected to the supply voltage VCC at terminal 43. The diode D1 is conductive during operation and is short-circuited, in other words bypassed, by means of the transistors TR1, TR2 and the resistor R1.

As mentioned, the gate terminal of the first transistor TR1 is connected to ground, in particular to terminal 44 (GND). If the source terminal of the transistors TR1, TR2 increases in voltage, in particular due to the supply with VCC_min=3.0V, the channel becomes conductive in parallel to the diode D1, i.e., via the transistor TR1. As a result, the forward voltage of diode D1 is eliminated. When supplied with VCC_min=3.0V, the levels shown in FIG. 7 can be generated under all conditions to be considered.

Just as with the polarity reversal diodes D_B, D_D, the polarity reversal circuit D_A also provides feedback protection. As described, the transistor TR2 is a PMOS transistor. The transistor TR2 is conductive when at its gate terminal, which is connected to the terminal 43, at least one threshold voltage below the potential is present at the source terminal of the transistor TR2. If the voltage at the cathode of the diode D1, which is equal to the potential of the source terminal of the second transistor TR2, rises by about one transistor threshold voltage above the voltage VCC at the terminal 43, the transistor TR2 becomes conductive, the voltage at the gate of the transistor TR1 rises and the transistor TRI blocks. As a result, the parasitic diode D1 becomes effective. As a result, feedback protection is present.

For this purpose, the transistors TR1, TR2 are designed in such a way that the on-resistance value of the second transistor TR2 is much smaller than the resistance value of the resistor R1. The following thus applies: Ron_TR2<<R1.

Optionally, the gate-source paths of the transistors TR1, TR2 are filtered, in particular with an RC filter formed by the resistor R1 and the capacitor C1. As a result, the polarity reversal circuit D_A is robust against pulsed disturbances, in particular DPI, ISO pulses, etc.

The second polarity reversal circuit D_C has a diode D2, a first transistor TR3, a second transistor TR4, a resistor R2 and optionally a capacitor C2. The diode D2 arises parasitically from the transistor TR3. The transistor TR4 has its own parasitic diode, which is not shown in FIG. 10. The transistors TR3, TR4 are PMOS transistors. The anode of diode D2 is connected to the drain terminal of the first transistor TR3. The cathode of the diode D2 is connected to the source terminal of the first transistor TR3 and to the source terminal of the second transistor TR4. The gate terminal of the first transistor TR3 is connected to the drain terminal of the second transistor TR4, to a terminal of the resistor R2 and to a terminal of the optional capacitor C2. The other terminal of resistor R2 is connected to ground, in particular to terminal 44 (GND). In addition, the other terminal of the capacitor C2 is connected to ground, in particular to terminal 44 (GND). The gate terminal of the second transistor TR4 is connected to the supply voltage VCC at terminal 43. The diode D2 is conductive during operation and is short-circuited, in other words bypassed, by means of the transistors TR3, TR4 and the resistor R2.

As mentioned, the gate terminal of the first transistor TR3 is connected to ground, in particular to terminal 44 (GND). If the source terminal of the transistors TR3, TR4 increases in voltage, in particular due to the supply with VCC_min=3.0V, the channel becomes conductive in parallel to the diode D2, i.e., via the transistor TR3. As a result, the forward voltage of diode D2 is eliminated. When supplied with VCC_min=3.0V, the levels shown in FIG. 7 can be generated under all conditions to be considered.

Just as with the polarity reversal diodes D_B, D_D, the polarity reversal circuit D_C also provides feedback protection. As described, the transistor TR4 is a PMOS transistor. The transistor TR4 is conductive when at its gate terminal, which is connected to the terminal 43, at least one threshold voltage below the potential is present at the source terminal of the transistor TR4. If the voltage at the cathode of the diode D2, which is equal to the potential of the source terminal of the second transistor TR4, rises by about one transistor threshold voltage above the voltage VCC at the terminal 43, the transistor TR4 becomes conductive, the voltage at the gate of the transistor TR3 rises and the transistor TR3 blocks. As a result, the parasitic diode D2 becomes effective. As a result, feedback protection is present.

For this purpose, the transistors TR3, TR4 are designed in such a way that the on-resistance value of the second transistor TR4 is much smaller than the resistance value of the resistor R3. The following thus applies: Ron_TR4<<R2.

Optionally, the gate-source paths of the transistors TR3, TR4 are filtered, in particular with an RC filter formed by the resistor R2 and the capacitor C2. As a result, the polarity reversal circuit D_C is robust against pulsed disturbances, in particular DPI, ISO pulses, etc.

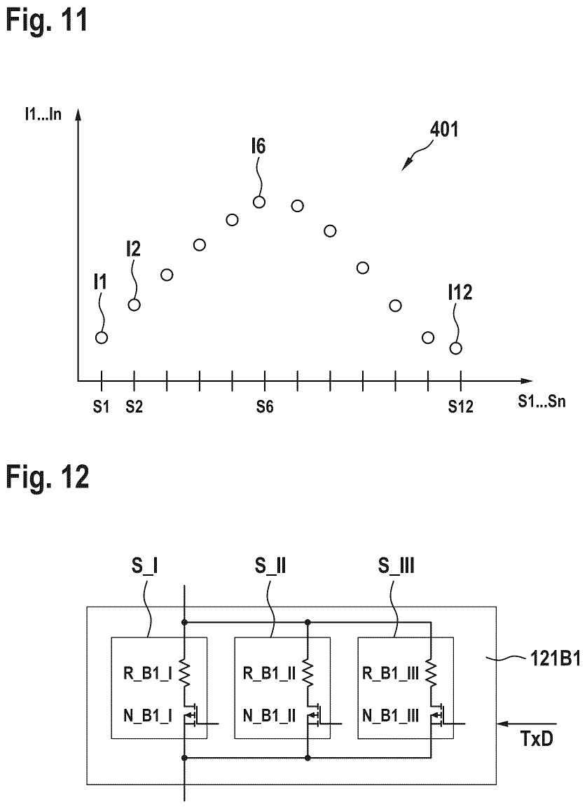

Each of the parallel circuits 121A1, 121B1, 121C1, 121D1, more precisely the associated control circuit T_A, T_B, T_C, T_D, sets a resistance value for the associated transmission stage 121A, 121B, 121C, 121D according to the operating mode (SLOW or SIC, FAST_TX) of the transmitting module 121 and the transmit signal TxD. The resistance value of the individual transmission stage 121A, 121B, 121C, 121D can thus be set depending on the operating mode (SLOW or SIC, FAST_TX) of the transmitting module 121 and the transmit signal TxD. This is described in more detail below on the basis of FIG. 11 and FIG. 12 as well as Table 2 and Table 3.

Each of the transistors HVP_A, HVN_B, HVP_C, HVN_D is an HV cascode and can also be called an HV standoff device. The transistor HVP_A protects the CMOS transistors P_A1 to P_An of the assigned parallel circuit 121A1 by absorbing high voltage drops. Each of the transistors HVN_B, HVP_C, HVN_D has the same function for the CMOS transistors of the corresponding assigned parallel circuit 121B1, 121C1, 121D1. Each of the transistors HVP_A, HVN_B, HVP_C, HVN_D is connected to terminal 125 at its control terminal. Thus, each of the transistors HVP_A, HVN_B, HVP_C, HVN_D can be controlled by the at least one control device 124.

The current limiting modules 1211, 1212 are each designed as a transistor. The current limiting modules 1211, 1212 in the example of FIG. 10 are each CMOS transistors. The current limiting module 1211 of FIG. 10 is a PMOS transistor. The current limiting module 1211 thus forms a current source. The current limiting module 1212 of FIG. 10 is a NMOS transistor. The current limiting module 1212 thus forms a current sink. The current limiting modules 1211, 1212 are provided for protecting the transmitting module 121 and the external components, in particular other components of the subscriber station 10 and/or the bus 40. The arrangement of the current limiting modules 1211, 1212 in the circuit of the transmission stage 121 is suitable for the dom state 401 and for the sic state 403 of FIG. 9. According to the design and specification, twice as much electric current flows in the dom state 401 as in the sic state, but in the dom state 401 the current flows only on one path of the transmitting module 121. In contrast, in the sic state, the current flows on two paths of the transmitting module 121. The two paths are designed or configured the same. Thus, the same voltage drop occurs at the current limiting modules 1211, 1212.

In the transmitting module 121, the transmission stage 121A is connected between the terminal 43 for the voltage supply and the terminal 41 (CANH) for the signal CAN_H. The transmission stage 121C is connected between the terminal 43 for the voltage supply and the terminal 42 (CANL) and the terminal 43 for ground or the terminal 44 (CAN_GND). The transmission stage 121D is connected between the terminal 41 (CANH) for the signal CAN_H and the terminal 43 for ground or the terminal 44 (CAN GND). The transmission stage 121B is connected between the terminal 42 (CANL) for the signal CAN_L and the terminal 43 for ground or the terminal 44 (CAN_GND). Thus, in the transmitting module 121, firstly the transmission stage 121A is connected into the CANH path. Secondly the transmission stage 121D is connected into the CANH path. Firstly the transmission stage 121C is connected into the CANL path. Secondly the transmission stage 121B is connected into the CANL path.

Thus, the transmitting module 121 consists, in the CANH path and in the CANL path, of a parallel circuit 121A1, 121B1, 121C1, 121D1 of a certain number of current stages. A single current stage is realized by a series circuit consisting of a CMOS switch and a resistor, as described above. The parallel connection of all current stages is connected, in the CANH path and in the CANL path, in series with an HV cascode HVP_A, HVN_B, HVP_C, HVN_D and a polarity reversal diode D_A, D_B, D_C, D_D, as described above. The HV cascodes HVP_A, HVN_B, HVP_C, HVN_D make it possible to comply with to limit values (maximum rating parameters), such as voltage at CANH and CANL of −27 V to +40 V.

The mode of operation of the circuit of FIG. 10 according to the operating mode of the transmitting module 121 and the bus state 401 (dom), 403 (sic), 402 (rec) in the SIC operating mode (arbitration phase 451) and L0, L1 in the data phase 452 is explained on the basis of the following Table 2. Table 2 indicates—according to the state of the transmitting module 121 and the operating mode of the phases 451, 452—the required impedance depending on the state of the transmitting module 121, as well as the impedance of the transmission stages 121A/121B and the impedance of the transmission stages 121C/121D.

TABLE 2
Required impedance according to transmission state

| | | CAN FD, CAN SIC, | | | | |
|---|---|---|---|---|---|---|
| | | CAN XL (xl_sic) | | | CAN XL | |
| | | (transmission | | | (xl_fasttx) | |
| Operating mode of | | operating mode | | | (transmission | |
| the transmitting | | in arbitration | | | operating mode in | |
| module 121 | | phase 451) | | | data phase 452) | |
| Bus state | | dom | Sic | rec | L0 | L1 |
| VDIFF in volts (V) | | 2 | 0 | 0 | 1 | −1 |
| Impedance | Required | Not | about 120, | infinite | about 120, | about 120, |
| | impedance | specified | for matching | | for matching | for matching |
| | in ohms (Ω) | | with Zw | | with Zw | with Zw |
| | between bus | | of 41, 42 | | of 41, 42 | of 41, 42 |
| | wire 41 | | | | | |
| | (CANH) and | | | | | |
| | 42 (CANL) | | | | | |
| | Transmission | about 30 | about 120 | infinite | about 60 | infinite |
| | stages | | | | | |
| | 121A/121B: | | | | | |
| | Typical | | | | | |
| | values in | | | | | |
| | ohms (Ω) | | | | | |
| | Transmission | infinite | about 120 | infinite | infinite | about 60 |
| | stages | | | | | |
| | 121C/121D: | | | | | |
| | Typical | | | | | |
| | values in | | | | | |
| | ohms (Ω) | | | | | |
| | Resulting | about 60 | about 120 | infinite | about 120 | about 120 |
| | impedance | | | | | |
| | in ohms (Ω) | | | | | |
| | between bus | | | | | |
| | wire 41 | | | | | |
| | (CANH) and | | | | | |
| | 42 (CANL) | | | | | |

If the impedance is “infinite”, the transmitting module 121 or the particular transmission stage 121A, 121B, 121C, 121D is switched off or switched so as to be non-conductive.

The division of each parallel circuit 121A1, 121B1, 121C1, 121D1 of FIG. 10 into n parts or the n current stages allows a temporally staggered and controlled switching process between the bus states 401, 402, 403 in the arbitration phase (SIC operating mode) 451 or between the bus states L0, L1 of the data phase 452. The resistance values of the resistors of the n current stages are set for this purpose, as illustrated with FIG. 11 in a specific example.

FIG. 11 shows an example of the current level for each switching stage or current stage S1 to S12. Thus, in the example shown, twelve current stages S1, S2 to S6 to S12 are used for each of the parallel circuits 121A1, 121B1, 121C1, 121D1. Therefore, n=12.

The value of the current I (vertical axis in FIG. 10) or I1, I2, I6, I12, etc. is set by the selection of the serial resistance value of the corresponding current stage S1 to S12. The individual current stages S1 to S12 (horizontal axis in FIG. 11) therefore have different resistance values.

To generate the bus states 401, 402, 403 in the arbitration phase (SIC operating mode) 451 or the bus states L0, L1 of the data phase 452, the individual current stages S1 to S12 are switched on or off with temporal offset using the CMOS transistors of the current stages S1 to S12. As a result, a corresponding electric current I flows in the CANH path or CANL path into which the superordinate transmission stage 121A, 121B, 121C, 121D is connected.

In general, it is advantageous to design the staggering (stagger stages) and resistors per switching stage or current stage S1 to S12 in such a way that the shape of the differential signal VDIFF follows the Gaussian error function. Analytically, this produces the lowest emission.

For the transition from a state 402 (recessive) to a state 401 (dominant), which corresponds to a rising edge of the differential voltage VDIFF of FIG. 5, the current in the CANH path and in the CANL path is gradually increased to generate a dominant level on the bus 40 by the temporally offset switching in of the resistors of the parallel circuits 121A1, 121B1, 121C1, 121D1. The transition from a state 401 (dominant) to a state 402 (recessive), which corresponds to a falling edge of the differential voltage VDIFF of FIG. 5, is carried out correspondingly by the temporally offset disconnecting of the resistors of the parallel circuits 121A1, 121B1, 121C1, 121D1, whereby the current in the CANH and CANL path is gradually reduced. The total current, which is given by the sum of the currents I1 to I12 or I1 to In of all current stages S1 to Sn, flows during the state 401 (dominant). Here, all current stages S1 to Sn of the parallel circuits 121A1, 121B1, 121C1, 121D1 are switched on and the total current for generating the dominant level of nominally VDIFF=2 V flows through the bus resistor or terminating resistor 49.

Due to the temporal setting and due to the selection of the current levels of the individual current stages S1 to S12 by setting the resistance values of their resistors, as described above, it is possible to align the bus signals CAN_H, CAN_L with one another during the transition between the states 401, 402, so that the symmetrical curve of CAN_H and CAN_L according to FIG. 7, or for the transmitting module 221 according to FIG. 4, is realized. The structure of the transmitting module 121 enables the individual current stages of the parallel circuits 121A1, 121B1, 121C1, 121D1 to be switched on with temporal offset. Due to this temporal control, it is possible to align the signal shape of CAN_H and CAN_L as required in FIG. 7 or FIG. 9 or FIG. 4. Specific shaping of the signal curves for CAN_H and CAN_L is possible. Overall, the bus states 401, 402, 403 in the arbitration phase (SIC operating mode) 451 or the bus states L0, L1 of the data phase 452 can be shaped according to the specifications.

The resistors of the individual current stages S1 to Sn of the parallel circuits 121A1, 121B1, 121C1, 121D1 and thus their corresponding share of the total current can be selected in different ways in order to achieve the lowest possible emission, in particular a low emission of the transmitting module 121. For low emission, it is advantageous to switch in or switch out little current I (high resistance value) at the beginning and end of a switching operation between bus states 401, 402 and to switch in or switch out much current (low resistance value) in the middle of the switching operation. Therefore, the setting of the currents of the current stages S1 to S12 that is shown in FIG. 11 is very advantageous.

In contrast to an implementation with identical resistors in the current stages S1 to Sn of the parallel circuits 121A1, 121B1, 121C1, 121D1, the configuration according to FIG. 10 avoids a current increase during the switch-off, the transition from the state 401 (dominant) to the state 402 (recessive).

The granularity of the temporal staggering for the switching on or off of the individual current stages S1 to S12 is in a range of about 2 ns. Small intervals or steps of this kind for the temporal staggering cause little common mode interference and have little negative impact on the emission. The voltage steps, which are set via the resistors or resistance stages of the current stages S1, S2 to S6 to S12, are kept fixed and the temporal staggering is varied so that, during the switch-on process, the smoothest possible behavior arises (according to the Gaussian error function). The variation of the time steps or time intervals also prevents the occurrence of a narrow-band frequency line in the emission frequency spectrum.

Alternatively, the staggering steps can be implemented using fixed time steps and varied voltage steps.

Due to the shown structure of the transmitting module 121, the symmetrical switching of the bus signals CAN_H and CAN_L (FIG. 7 or 9 or 4) with steep switching edges between the bus states 401, 402, 403 in the arbitration phase (SIC operating mode) 451 or between the bus states L0, L1 of the data phase 452 is made possible.

Firstly, the illustrated structure of the transmitting module 121 realizes much steeper switching edges between the bus states 401, 402, 403 in the arbitration phase (SIC operating mode) 451 or between the bus states L0, L1 of the data phase 452 due to the use of fast CMOS switches or CMOS transistors. Secondly, the symmetry of the time profiles of the bus signals CAN_H and CAN_L which is necessary to comply with the emission limit values is achieved during the switching processes. Matching of the characteristic curves is achieved by the selection or use of the resistors of the parallel circuits 121A1, 121B1, 121C1, 121D1. This means that the matching of the characteristic curves is less dependent on the parameters of the transistors used in the parallel circuits 121A1, 121B1, 121C1, 121D1.

The CMOS transistors of the transmission stages 121A1, 121B1, 121C1, 121D1 are operated as switches, i.e., with a maximum voltage between the gate terminal and the source terminal. The matching of the individual transmission stages 121A1, 121B1, 121C1, 121D1 therefore depends largely on the matching of the resistors R_A1 to R_An, R_B1 to R_Bn, R_C1 to R_Cn, R_D1 to R_Dn and no longer on the transistors P_A1 to P_An and P_C1 to P_Cn (PMOS) on the bus wire 41 (CANH) and the transistors N_D1 to N_Dn and N_B1 to N_Bn (NMOS) on the bus wire 42 (CANL).

The dominant state 401 (dom) is determined by matching of the resistors R_A1 to R_An (transmission stage 121A) with the resistors R_B1 to R_Bn (transmission stage 121B). Here and in the following, the term “matching” means, according to one possibility, an active trimming step. According to another possibility, “matching” means that the resistance values are as compatible as possible, which standardly occurs without a matching step or trimming step.

The sic state (sic) is determined by matching of the resistors R_A1 to R_An (transmission stage 121A) with the resistors R_C1 to R_Cn (transmission stage 121C) and by matching of the resistors R_D1 to R_Dn (transmission stage 121D) with the resistors R_B1 to R_Bn (transmission stage 121B).

In the XL Fast operating mode, the state L0 is determined by matching of the resistors R_A1 to R_An (transmission stage 121A) with the resistors R_B1 to R_Bn (transmission stage 121B). The state L1 is determined by matching of the resistors R_C1 to R_Cn (transmission stage 121C) with the resistors R_D1 to R_Dn (transmission stage 121D).

The on-resistance Ron of the respective transistors of the transmission stages 121A1, 121B1, 121C1, 121D1 should be significantly smaller than the corresponding series-connected resistance of the individual current stages of the transmission stages 121A1, 121B1, 121C1, 121D1.

FIG. 12 shows a specific example of the structure of the transmission stage 121B of FIG. 10. According to this, the transmission stage 121B has three current stages S_I, S_II, S_III in the parallel circuit 121B1. The first current stage S_I has a resistor R_B1_I and a transistor N_B1_I which is connected in series. The second current stage S_II has a resistor R_B1_II and a transistor N_B1_II which is connected in series. The third current stage S_III has a resistor R_B1_III and a transistor N_B1_III which is connected in series.

For the following description of the circuit of FIG. 10 with the configuration according to FIG. 11, it is assumed that each of the transmission stages 121A, 121C, 121D likewise has three current stages S_I, S_II, S_III in its associated parallel circuit 121A1, 121C1, 121D1 in accordance with the example of FIG. 12.

The following Table 3 shows the control of the three transistors N_B1_I, N_B1_II, N_B1_III of the transmission stage 121B of FIG. 12 and of the corresponding transistors of the transmission stages 121A, 121C, 121D of FIG. 10, according to the transmission stages 121A/121B and the transmission stages 121C, 121D.

TABLE 3
Required impedance according to transmission state

| | CAN FD, CAN SIC, | | | | |
|---|---|---|---|---|---|
| Operating | CAN XL (xl_sic) | | | CAN XL (xl_fasttx) | |
| mode of the | (transmission operating | | | (transmission | |
| transmitting | mode in arbitration | | | operating mode in | |
| module 121 | phase 451) | | | data phase 452) | |
| Bus state | dom | sic | rec | L0 | L1 |
| 121A/121B: | about | about | infinite | about | infinite |
| Typical values | 30 | 120 | | 60 | |
| in ohms (Ω) | | | | | |
| Transistor I | in | in | out | in | out |
| Transistor II | in | out | out | in | out |
| Transistor III | in | out | out | out | out |
| 121C/121D: | infinite | about | infinite | infinite | about |
| Typical values | | 120 | | | 60 |
| in ohms (Ω) | | | | | |
| Transistor I | out | in | out | out | in |
| Transistor II | out | out | out | out | in |
| Transistor III | out | out | out | out | out |

In this way, with the transmitting module 121 the required steeper edges on the bus signals CAN_H and CAN_L can be generated and the emission limit values can be complied with.

Alternatively, more than three current stages can be used in each of the transmission stages 121A, 121B, 121C, 121D, as described above.

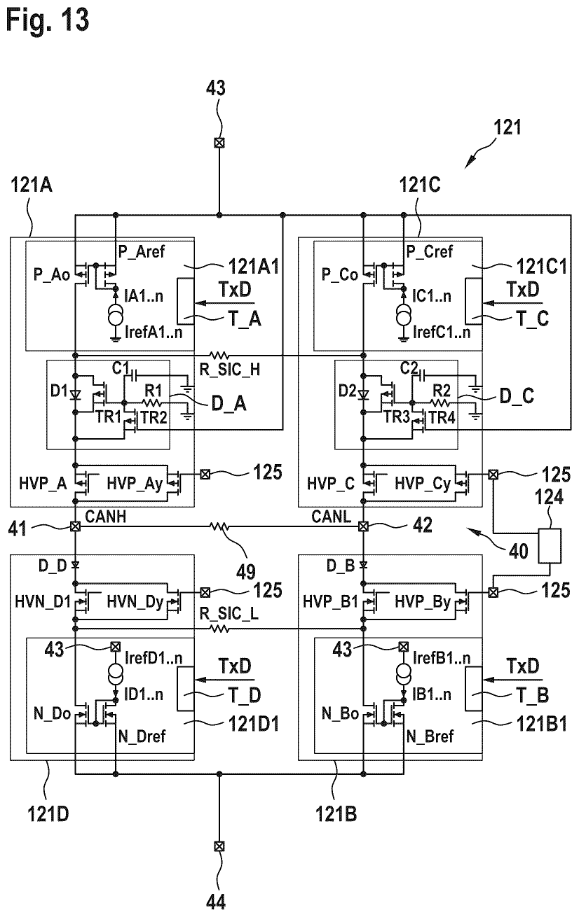

FIG. 13 shows a transmitting module 1210 according to a second exemplary embodiment. The transmitting module 1210 is constructed, in many parts, in the same way as the transmitting module 121 according to the first exemplary embodiment. Therefore, only the differences from the first exemplary embodiment are described below.

In contrast to the first exemplary embodiment, the transmitting module 1210 according to the present exemplary embodiment has transmission stages 121A0, 121B0, 121C0, 121D0. The transmission stages 121A0, 121B0, 121C0, 121D0 are connected as a full bridge. The terminating resistor 49 is connected in the bridge branch between the terminals for the bus wires 41, 42. Moreover, instead of the current limiting modules 1211, 1212 the transmitting module 1210 has a first to x-th current limiting module 1211_1 to 1211x and a first to x-th current limiting module 1212_1 to 1212_x. Here, x is a natural number >1.

The current limiting modules 1211_1 to 1211_x, 1212_1 to 1212_x are each designed as transistors. The current limiting modules 1211_1 to 1211_x, 1212_1 to 1212_x in the example of FIG. 13 are each CMOS transistors. The current limiting modules 1211_1 to 1211_x of FIG. 13 are each a PMOS transistor. Thus, the current limiting modules 1211_1 to 1211_x each form a current source. The current limiting modules 1212_1 to 1212_x of FIG. 13 are each a NMOS transistor. Thus, the current limiting modules 1212_1 to 1212_x each form a current sink.

In contrast to the transmission stage 121A of the first exemplary embodiment, which has the transistor HVP_A, the transmission stage 121A0 has a first to y-th transistor HVP_A1 to HVP_Ay, y being a natural number >1. Each of the first to y-th transistors HVP_A1 to HVP_Ay is a CMOS transistor, in particular PMOS transistor, as described above for the transistor HVP_A with reference to FIG. 10.

In contrast to the transmission stage 121B of the first exemplary embodiment, which has the transistor HVN_B, the transmission stage 121B0 has a first to y-th transistor HVN_B1 to HVN_By, y being a natural number >1. Each of the first to y-th transistors HVN_B1 to HVN By is a CMOS transistor, in particular NMOS transistor, as described above for the transistor HVP_B with reference to FIG. 10.

In contrast to the transmission stage 121C of the first exemplary embodiment, which has the transistor HVP_C, the transmission stage 121C0 has a first to y-th transistor HVP_C1 to HVP_Cy, y being a natural number >1. Each of the first to y-th transistors HVP_C1 to HVP_Cy is a CMOS transistor, in particular PMOS transistor, as described above for the transistor HVP_C with reference to FIG. 10.

In contrast to the transmission stage 121D of the first exemplary embodiment, which has the transistor HVN_D, the transmission stage 121D0 has a first to y-th transistor HVN_D1 to HVN_Dy, y being a natural number >1. Each of the first to y-th transistors HVN_D1 to HVN_Dy is a CMOS transistor, in particular NMOS transistor, as described above for the transistor HVP_D with reference to FIG. 10.

In addition to the functions of the transmitting module 121 according to the first exemplary embodiment, the transmitting module 1210 of FIG. 13 has the following functions.

Due to its design, the transmitting module 1210 is able to reduce effects due to asymmetrical behavior of the transmission stages, which effects are possible in the transmission states dom (401), sic (403), rec (402), and increase the overshoot and therefore worsen the emission. The transmitting module 1210 prevents unequal behavior of components in the transmission stages 121A0, 121B0 (effect 1) of the full bridge of FIG. 13, so that in the dom state 401 a change in the common mode voltage in comparison with the rec state 402 is minimized or prevented.

In order to prevent effect 1, the resistance Ron (on-resistance) of the cascodes in the transmission stages 121A0, 121B0 can be changed, in particular by control with the corresponding associated control circuit T_A, T_B. This is done by changing the up to y transistors HVP_A1 to HVP_Ay connected in parallel and/or the up to y transistors HVN_B1 to HVN_By connected in parallel. In order not to change the symmetry of the two series circuits of the transmission stages 121A0, 121D0 and of the transmission stages 121C0, 121B0 in the sic state 403, the cascodes of the transmission stages 121D0, 121C0 must also undergo the same change. Therefore, the up to y transistors HVN_D1 to HVP_Dy connected in parallel and/or the up to y transistors HVP_C1 to HVP_Cy connected in parallel are also changed accordingly. For this purpose, each of the transistors HVP_A1 to HVP_Ay, HVN_B1 to HVN_By, HVP_C1 to HVP_Cy, HVN_D1 to HVP_Dy is connected, at its control terminal (gate terminal), to a terminal 125. Thus, each of these transistors can be controlled by the at least one control device 124. The intervention to correct the common mode level in the dom state 401 is carried out via a similar or same change of HVP_A1 to HVP_Ay and HVP_C1 to HVP_Cy or via a similar or same change of HVP_D1 to HVN_Dy and HVP_B1 to HVN_By.

In addition, the transmitting module 1210 can prevent unequal behavior of components in transmission stages 121A0/121D0 and 121C0/121B0 of the full bridge (effect 2), so that in the sic state a change in the common mode voltage in comparison with the rec state 402 is minimized or prevented.

For this purpose, the resistance Ron (on-resistance) of the current limiting transistors or current limiting modules 1211, 1212 can be changed. This is done via the up to x current limiting modules 1211_1 to 1211_x connected in parallel and/or the up to x current limiting modules 1212_1 to 1212_x connected in parallel, in particular by control by the at least one control device 124. The intervention to correct the common mode level in the sic state 403 is carried out via the up to x current limiting modules 1211_1 to 1211_x connected in parallel or the up to x current limiting modules 1212_1 to 1212_x connected in parallel. For example, the following applies: x=4. In that case, four different stages of the resistance Ron (on-resistance) of the current limiting transistors or current limiting modules 1211, 1212) can be set.

This prevention of effect 2 is particularly advantageous, since only if, starting from the common mode level of the rec state 402, the common levels in the dom state 401 and in the sic state 403 match those of the rec state 402, a sufficient emission result can be achieved, but the causes that lead to the behavior of effect 1 may be different from those that lead to effect 2.

Due to the design of the transmitting module 1210, it can be prevented, in particular, that substrate current losses in the polarity reversal diodes D_A and D_B cause the common mode level in the dom state 401 to no longer be correct. In the sic state, the polarity reversal circuit D_A and the polarity reversal diode D_B are less strongly current-carrying and furthermore both polarity reversal diodes D_B, D_D of the four transmission stages 121A0, 121B0, 121C0, 121D0 are active. The transmitting module 1210 can prevent different common mode levels from being present in the dom state and in the sic state. In addition, the generation of qualitatively identical effects by unequal behavior in the cascodes can be prevented.

Thus, the transmitting module 1210 can positively influence the effects on the emission values of the transmitting/receiving device 12, which are significantly influenced by the transmitting module 1210.

All above-described embodiments of the transmitting module 121, 1210, of the transmitting/receiving devices 12, 22, of the subscriber stations 10, 20, 30, of the bus system 1 and of the method carried out therein according to the first and second exemplary embodiment and their modifications can be used individually or in all possible combinations. Additionally, the following modifications are possible in particular.

The above-described bus system 1 according to the first and second exemplary embodiment is described on the basis of a bus system based on the CAN protocol. However, the bus system 1 according to the first and/or second exemplary embodiment may alternatively be another type of communication network in which the signals are transmitted as differential signals. It is advantageous, but not necessarily a prerequisite, for exclusive, collision-free access of a subscriber station 10, 20, 30 to the bus 40 to be ensured in the bus system 1, at least for certain time periods.

The bus system 1 according to the first and/or second exemplary embodiment and their modifications is in particular a CAN bus system or a CAN HS bus system or a CAN FD bus system or a CAN SIC bus system or a CAN XL bus system. However, the bus system 1 may be another communication network in which the signals are transmitted as differential signals and serially over the bus.

Thus, the functionality of the above-described exemplary embodiments can be used, for example, in transmitting/receiving devices 12, 22 that can be operated in a CAN bus system or a CAN HS bus system or a CAN FD bus system or a CAN SIC bus system or a CAN XL bus system.

It is possible that, for the two bus states 401, 402, at least temporarily, a dominant bus state and a recessive bus state are not used, but instead a first bus state and a second bus state which are both driven are used. An example of such a bus system is a CAN XL bus system.

The number and arrangement of the subscriber stations 10, 20, 30 in the bus system 1 according to the first and second exemplary embodiment and their modifications is arbitrary. In particular, only subscriber stations 10 or only subscriber stations 30 are present in the bus systems 1 of the first or second exemplary embodiment.

What is claimed is:

1. A transmitting module for transmitting differential signals in a serial bus system, the transmitting module comprising:
a first transmission stage configured to generate transmission currents for a first signal that is to be transmitted onto a bus of the bus system;
a second transmission stage configured to generate transmission currents for a second signal that is to be transmitted onto the bus as a signal that is differential to the first signal;
a third transmission stage configured to generate transmission currents for the first signal; and
a fourth transmission stage configured to generate transmission currents for the second signal;
wherein the first, the second, the third, and the fourth transmission stages are connected in a full bridge, in which the first and the fourth transmission stages are connected in series and the third and the second transmission stages are connected in series,
wherein each of the first, the second, the third, and the fourth transmission stages has at least two current stages connected in parallel with one another, each of the at least two current stages having a switchable resistor,
wherein the switchable resistors of each transmission stage have different resistance values,
wherein the first, the second, the third, and the fourth transmission stages each have a polarity reversal diode for protection against positive feedback into a terminal for a bus voltage supply and negative feedback from a terminal for ground,
wherein the polarity reversal diode of the first transmission stage and the third transmission stage is each a switched polarity reversal diode that can be bypassed or short-circuited, and
wherein the polarity reversal diode of the second transmission stage and the fourth transmission stage is each a pn-based polarity reversal diode that is a parasitic of a transistor and is hard-wired so that the polarity reversal diode cannot be bypassed or short-circuited.

2. The transmitting module according to claim 1, wherein the output terminals of the full bridge are provided for connection to a terminating resistor of the bus.

3. The transmitting module according to claim 1, wherein the polarity reversal diodes are configured to set a bus midpoint voltage of about 1.9 V when the transmitting module is operated with a voltage supply of about 3.3 V.

4. The transmitting module according to claim 1, wherein:
each transmission stage of the first transmission stage and the third transmission stage each have a polarity reversal circuit which has the polarity reversal diode of the transmission stage, a first transistor, a second transistor, and a resistor,
wherein the second transistor of each polarity reversal circuit has an on-resistance value that is much smaller than a resistance value of the resistorof the polarity reversal stage of the transmission stage.

5. The transmitting module according to claim 4, wherein:
wherein a drain terminal of the first transistor of each polarity reveral circuit of each transmission stage of the first and the third transmission stage is connected to an anode of the polarity reversal diode of the transmission stage,
wherein source terminals of the first and the second transistors of each polarity reversal circuit are connected to a cathode of the polarity reversal diode of the transmission stage,
wherein gate terminal of the first transistor of each polarity reversal circuit is connected to a drain terminal of the second transistor the polarity reversal stage and is connected to the terminal for ground via the resistor,
wherein a gate terminal of the second transistor of each polarity reversal circuit is connected to the terminal for the bus voltage supply.

6. The transmitting module according to claim 4, wherein a path from the gate terminal to the source terminal of the first transistor of each polarity reversal filter has a filter for protection against pulsed disturbances.

7. The transmitting module according to claim 1, wherein a number n of the at least two current stages is the same for each of the first, the second, the third, and the fourth transmission stages, n being a natural number greater than 1.

8. The transmitting module according to claim 1, wherein each current stage of the at least two current stages of each of the first, the second, the third, and the fourth transmission stages has a CMOS transistor for switching the switchable resistor of the current stage.

9. The transmitting module according to claim 8, wherein:
the CMOS transistor of the current stages of the first transmission stage is a PMOS transistor,
the CMOS transistor of the current stages of the second transmission stage is an NMOS transistor,
the CMOS transistor of the current stages of the third transmission stage is a PMOS transistor, and
the CMOS transistor of the current stages of the fourth transmission stage is an NMOS transistor.

10. The transmitting module according to claim 8, wherein each of the first, the second, the third, and the fourth transmission stages further has at least one cascode for protecting the CMOS transistors of the first, the second, the third, and the fourth transmission stages, respectively.

11. The transmitting module according to claim 10, wherein
at least two cascodes are connected in parallel with one another,
a number y of the cascodes of each of the first, the second, the third, and the fourth transmission stages is the same for each of the first, the second, the third, and the fourth transmission stages, y being a natural number greater than 1, and
an on-resistance of the at least two cascodes is different.

12. The transmitting module according to claim 1, further comprising:
at least one first current limiting module as a current source, which is connected between the terminal for the bus voltage supply and the full bridge; and
at least one second current limiting module as a current sink, which is connected between the terminal for ground and the full bridge.

13. The transmitting module according to claim 12, wherein:
at least two first current limiting modules are connected in parallel to one another, an on-resistance of which is different,
at least two second current limiting modules are connected in parallel to one another, an on-resistance of which is different, and
a number x of the first current limiting modules is equal to a number x of the second current limiting modules, x being a natural number greater than 1.

14. The transmitting module according to claim 1, further comprising:
a control circuit configured to control switchable components of the first, the second, the third, and the fourth transmission stages according to a digital transmit signal and according to an operating mode set for the transmitting module.

15. The transmitting module according to claim 14, wherein the control circuit is configured for a temporally staggered and controlled switching of resistance values of the at least two current stages of the first, the second, the third, and the fourth transmission stages.

16. A transmitting/receiving device for a subscriber station for a serial bus system, comprising:
a transmitting module, including:
a first transmission stage configured to generate transmission currents for a first signal that is to be transmitted onto a bus of the bus system;
a second transmission stage configured to generate transmission currents for a second signal that is to be transmitted onto the bus as a signal that is differential to the first signal;
a third transmission stage configured to generate transmission currents for the first signal; and
a fourth transmission stage configured to generate transmission currents for the second signal;
wherein the first, the second, the third, and the fourth transmission stages are connected in a full bridge, in which the first and the fourth transmission stages are connected in series and the third and the second transmission stages are connected in series,
wherein each of the first, the second, the third, and the fourth transmission stages has at least two current stages connected in parallel with one another, each of the at least two current stages having a switchable resistor,
wherein the switchable resistors of each transmission stage have different resistance values,
wherein the first, the second, the third, and the fourth transmission stages each have a polarity reversal diode for protection against positive feedback into a terminal for a bus voltage supply and negative feedback from a terminal for ground,
wherein the polarity reversal diode of the first transmission stage and the third transmission stage is each a switched polarity reversal diode that can be bypassed or short-circuited, and
wherein the polarity reversal diode of the second transmission stage and the fourth transmission stage is each a pn-based polarity reversal diode that is a parasitic of a transistor and is hard-wired so that the polarity reversal diode cannot be bypassed or short-circuited; and
a receiving module configured to receive signals from the bus.

17. A subscriber station for a serial bus system, comprising:
a transmitting/receiving device, including:
a transmitting module, including:
a first transmission stage configured to generate transmission currents for a first signal that is to be transmitted onto a bus of the bus system;
a second transmission stage configured to generate transmission currents for a second signal that is to be transmitted onto the bus as a signal that is differential to the first signal;
a third transmission stage configured to generate transmission currents for the first signal; and
a fourth transmission stage configured to generate transmission currents for the second signal;
wherein the first, the second, the third, and the fourth transmission stages are connected in a full bridge, in which the first and the fourth transmission stages are connected in series and the third and the second transmission stages are connected in series,
wherein each of the first, the second, the third, and the fourth transmission stages has at least two current stages connected in parallel with one another, each of the at least two current stages having a switchable resistor,
wherein the switchable resistors of each transmission stage have different resistance values,
wherein the first, the second, the third, and the fourth transmission stages each have a polarity reversal diode for protection against positive feedback into a terminal for a bus voltage supply and negative feedback from a terminal for ground,
wherein the polarity reversal diode of the first transmission stage and the third transmission stage is each a switched polarity reversal diode that can be bypassed or short-circuited, and
wherein the polarity reversal diode of the second transmission stage and the fourth transmission stage is each a pn-based polarity reversal diode that is a parasitic of a transistor and is hard-wired so that the polarity reversal diode cannot be bypassed or short-circuited; and
a receiving module configured to receive signals from the bus; and
a communication control device configured to control communication in the bus system and to generate a digital transmit signal to controle the first, the second, the third, and the fourth transmission stages.

18. The subscriber station according to claim 17, wherein the subscriber station is configured for communication in a bus system in which an exclusive, collision-free access of a subscriber station to the bus of the bus system is guaranteed at least temporarily.

19. A method for transmitting differential signals in a serial bus system, wherein the method is carried out with a transmitting module, and wherein the method comprises the following steps:
generating, with a first transmission stage of the transmitting module, transmission currents for a first signal to be sent to a bus of the bus system;
generating, with a second transmission stage of the transmitting module, transmission currents for a second signal to be sent to the bus as a signal differential to the first signal;
generating, with a third transmission stage of the transmitting module, transmission currents for the first signal; and
generating, with a fourth transmission stage of the transmitting module, transmission currents for the second signal;
wherein the first, the second, the third, and the fourth transmission stages are connected in a full bridge, in which the first and the fourth transmission stages are connected in series and the third and the second transmission stages are connected in series,
wherein each of the first, the second, the third, and the fourth transmission stages has at least two current stages connected in parallel with one another,
wherein each of the at least two current stages of the first, the second, the third, and the fourth transmission stages has a switchable resistor,
wherein the switchable resistors of each transmission stage of the first, the second, the third, and the fourth transmission stages, have different resistance values,
wherein the first, the second, the third, and the fourth transmission stages each use a polarity reversal diode for protection against positive feedback into a terminal for a bus voltage supply and negative feedback from a terminal for ground,
wherein the polarity reversal diode of the first transmission stage and the third transmission stage is each a switched polarity reversal diode that can be bypassed or short-circuited, and
wherein the polarity reversal diode of the second transmission stage and the fourth transmission stage is each a pn-based polarity reversal diode that is a parasitic of a transistor and is hard-wired so that the polarity reversal diode cannot be bypassed or short-circuited.
